(19) United States
(12) Patent Application Publication
(10) Pub. No.: US 2023/0364706 A1
(43) Pub. Date: Nov. 16, 2023

(54) BEAM SHAPING SYSTEM IN THE PROCESS OF LASER WELDING

(71) Applicant: IPG PHOTONICS CORPORATION, Marlborough, MA (US)

(72) Inventors: Iurii MARKUSHOV, Shrewsbury, MA (US); Alex ZELENCHUK, Stoughton, MA (US); Yuri GRAPOV, Sutton, MA (US); Nikhit NAIR, Northborough, MA (US)

(73) Assignee: IPG PHOTONICS CORPORATION, Marlborough, MA (US)

(21) Appl. No.: 18/029,423

(22) PCT Filed: Oct. 8, 2021
(86) PCT No.: PCT/US21/54138

§ 371 Date: Mar. 30, 2023

Related U.S. Application Data
(60) Provisional application No. 63/090,062, filed on Oct. 9, 2020.

(51) Int. Cl. B23K 26/06; B23K 26/21

(52) U.S. Cl. CPC B23K 26/0648; B23K 26/21; B23K 26/0643

(57) ABSTRACT

A beam-shaper for transforming a MM beam with the flattop intensity distribution profile includes an end block which is fused to a downstream end of a fiber outputting the MM beam along a path within a laser head. The beam-shaper further has a collimator mounted to the laser head downstream from the end block. The collimated MM beam is then focused on the working zone with a beam waist characterized by a Gaussian intensity profile. The Gaussian region may be provided in the vicinity of the beam waist by positioning the collimator so that the Gaussian region of the MM flattop beam is located inside the end block and in the focal plane of the collimator. Alternatively, the Gaussian region may be provided within the waist by using a diffractive optical element which transforms the flattop distribution profile into a donut-shaped profile.

### BACKGROUND OF THE DISCLOSURE

### Field of the Disclosure

The disclosure relates to material processing applications of lasers. In particular, the disclosure relates to a beam shaping system incorporated in industrial lasers.

### Background Art Discussion

Beam shaping is the process of redistributing the irradiance and phase of a beam optical radiation. The beam shape is a major factor in determining the propagating properties of the beam profile. Applications of beam shaping include, among others, metal working applications, which, previously, had been done using conventional high-flux heat sources, such as reacting gas jets, electric discharges, and plasma arcs. In laser welding, two adjacent or stacked metal pieces are fused together by melting the parts at the weld line.

There are three basic weld modes which correspond to the level of peak power density, contained within the focus spot size: conduction mode, transition keyhole mode and penetration or keyhole mode. Each mode has its advantages and disadvantages. For example, in the key-hole mode, it is highly desirable that the key-hole have constant width and depth along the welding region. In reality, however, the uniform key-hole is practically impossible to create due to a so-called key-hole collapse phenomenon well known to one of ordinary skill. Another detrimental characteristic of the key-hole process is the formation of pores and cracks. Overall, the key-hole process is unstable. The conduction mode is known for its stability since vaporization is minimal. However, due to relatively low levels of power, weld penetration is considerably smaller than that of the key-hole process. To obtain the desired result it is necessary to form a very large heat affected zone which causes a high heat input and therefore distortion of the workpiece. In each mode, the melt-pool characteristics depend on the laser parameters including, among others energy, fluence and spot size.

The beam shape, as well known to one of ordinary skill, is defined by the irradiance distribution of the shaped beam. The irradiation (also referred to as intensity or power density) of a single mode (SM) beam is mathematically described by a Gaussian function and thus has a bell-like shape. Many applications can only benefit from the Gaussian beam, but, as well known, a power of individual SM lasers may be inadequately low for processing/welding certain materials.

To overcome this problem a plurality of SM outputs from respective lasers are combined in a single beam having more than a single mode and thus further referred to as a multimode (MM) beam. Typically, a MM output beam having an M² factor indicator of the number of modes—ranging between 2 and 10 and even 20 may be referred to as a low mode (LM) beam. However since both MM and LM beams each have more than one mode, within the context of this disclosure the flat-top laser beam has the M² factor ranging between 2 and 20 and is still referred to as MM beam.

Due to the mode beating along the light path including a MM delivery fiber, the resulting intensity profile of the MM beam at the fiber's downstream end has a flattop shape. The top-flat intensity profile of MM beam is advantageous for many material laser-processing operations because of a substantially uniform distribution of intensity across the beam in the focal plane.

Propagating further along the path including various optical elements, such as a focusing lens, the MM beam has multiple beam regions including a beam waist formed in the focal plane of the focusing lens. The waist is the narrowest beam region and thus has the highest power density along the beam. While the beam waist is characterized by the same flattop intensity distribution, beam regions located before the waist have respective intensity profiles which may differ from the flattop shape. One of these pre-waist beam regions, which is spaced at a large distance from the waist, is characterized by a quasi-Gaussian intensity profile. The beam region where the beam acquires the quasi-Gaussian intensity is further referred to as the (upper) Gaussian region. The propagating beam is symmetrical relative to its waist. Accordingly, a second Gaussian region is spaced downstream from the waist at the same distance as the distance between the upper region and waist.

One of ordinary skill in the laser-based material processing arts is well aware that the Gaussian beam is associated with high quality welds. Due to its bell-shaped intensity distribution profile, the intensity is not uniformly distributed across the beam spot with the highest intensity in the central apex area gradually decreasing towards the base perimeter. This profile creates a smooth temperature gradient across the surface to be laser treated because it allows to first gradually heat the irradiated area by the leading wing, then be treated by the intensity peak and finally gradually cool by the trailing wing. Such thermal dynamics is attractive to quite a few material processing methods. Regardless of the shape, a laser beam is delivered to the welding zone through the utmost downstream component of any industrial laser system-laser head.

FIG. 1 illustrates an exemplary laser head 25 which is typically mounted to a robotic arm. The laser head 25 encloses a beam guiding schematic which steers a MM flattop laser beam 10 after a delivery fiber 22 outputs it into the laser head. The optical schematic includes an end block 15 which is fused to the downstream end of delivery fiber 22 which receives combined beam 10 from the combiner combining outputs from respective SM laser sources. As known to one of ordinary skill in the laser arts, end block 15 is typically made from quartz and configured to prevent fiber end 22 from burning which would be otherwise inevitable at industrial laser power levels ranging between hundreds of watts and megawatts. The beam 10 diverges while propagating through and beyond end block 15 before it impinges on a collimating lens or collimator 1. The collimator 1 is an optical element changing beam 10, which diverges from downstream fiber end 22, into a beam of parallel rays. Accordingly, downstream fiber end 22 is placed in focus, i.e., spaced from collimator 1 at a distance equal to the collimator's focal length F1.

A focal lens 6 with a focal length F2 focuses collimated beam 10 on a surface 12 forming thus a beam waist which has the flattop intensity profile. The Gaussian region 14 of focused beam is spaced from the beam's waist.

One of the important factors related to beam divergence is the depth of field (DOF) which is closely associated with a so-called process window. In the context of materials processing, the DOF is the distance the laser treated workpiece can be moved away from the center of the beam waist while still maintaining the focal beam size. More specifically, it can be defined as the Rayleigh range well known to one of ordinary skill in the optical arts. In the above disclosed schematics, the largest Rayleigh range is in the beam waist. The Rayleigh range in Gaussian regions 14 is much smaller than that in the waist. The small DOF is inconvenient in laser-based material processing applications for the reasons explained below.

To operate in Gaussian region 14 beam 10 should be defocused. This can be accomplished by displacing focal lens 6 and surface 12 relative to one another. Yet the result of defocusing may not be acceptable since each region 14 may have an insufficient energy because the light spot formed by this region on the surface is large. If, for example, the light spot is changed by defocusing beam 10 at more than 10%, then the power density radically reduces since the density and spot size are quadratically related to one another. Even if the power density is sufficient, the DOF in Gaussian region 14 is small. It means both the part tolerance (workpieces to be welded are often not ideally uniform) and/or robot motion-caused error can critically affect the quality of the weld. Thus the operation of robots during welding by using Gaussian region 14 of beam 10 is extremely difficult to control which leads to a sophisticated software translating into high manufacturing costs.

It would be highly advantageous to configure the laser welding apparatus with a beam shaping system which can transform beam 10 such that its Gaussian region 14 was located within the beam waist. The latter leads to the enlarged. DOF which minimizes detrimental effects by robot-motion mistakes, increases energy. The enlarged DOF also helps minimize the damage to expensive but not always uniform workpieces.

It is, therefore, desirable to provide a beam shaping system in industrial laser-based robotic welding apparatus configured to form the waist of the flat-top MM beam, which is characterized by a Gaussian intensity distribution, on the surface of the workpiece to be laser treated.

Still another need exists for a laser-based material process incorporating the improved beam shaping system.

### BRIEF SUMMARY OF THE DISCLOSURE

The disclosed apparatus is configured to take into account at least some of the above discussed considerations. It generally includes a laser source, preferably a fiber laser source or YAG source, which may include multiple SM continuous wave (CW), quasi CW or pulsed lasers, outputting a MM laser beam with M² factor, which ranges between 2 and 20 and the power of up 20 kW, but higher powers are a distinct possibility. The MM flattop laser beam is guided along a delivery fiber which is fused to a quartz block mounted to a laser head and configured to prevent the burning of the fiber's end. Expanding in the quartz block, the flattop laser beam is guided through a laser head along a path by guiding optics that may include among others, a collimator and focusing lens. Preferably, but not necessarily, a scanner including a couple of movable mirrors is also mounted in the laser head, as disclosed in detail in US20160368089 and US20180369964 fully incorporated herein by reference.

The laser head is provided with the inventive beam shaping system which is configured to transform the laser beam with a flat-top intensity distribution to a Gaussian intensity distribution profile. In contrast to the known prior art shown in FIG. 1 where the Gaussian regions are located far outside the beam waist, the inventive schematic provides for placing the Gaussian region either in the immediate vicinity of the waist or exactly within the waist.

In accordance with one aspect of the disclosed schematic, this is accomplished by providing the beam-shaping system with an additional diffractive element, such as an axicon, homogenizer and others. The axicon lens unlike a converging lens, which is designed to focus a light source to a single point on the optical axis, uses interference to create a focal line along the optical axis. Within the beam overlap region referred to as DOF, the axicon replicates the properties of a Bessel beam, a beam comprised of rings equal in power to one another.

The Bessel beam, unsurprisingly, may be mathematically described by the Bessel function with a cross-plane intensity profile including a set of concentric rings in focal plane, example, for a zeroth-order beam, the Basel beam intensity profile has a donut-shaped cross-plane charactetized by a relatively low energy; for a first-order, the cross plane has a light spot in the very center.

Using such a diffractive element allows recreating the region of the MM beam with the Gaussian intensity very close to the beam waist without displacing the focusing lens. In other words, this schematic forms the Gaussian region practically adjacent to and even within the waist. Recreating the Gaussian region next to and practically within the waist increases the DOF and increases the energy by comparison with the prior art schematic of FIG. 1.

In the above-disclosed schematic, the downstream end of the delivery fiber and collimator are spaced from one another at the focal length of the collimator. But for the additional diffractive optical element, the Gaussian region is located farther away from the waist, as discussed in reference to the prior art of FIG. 1.

Still another aspect of the invention does not involve the additional diffractive element. In contrast to the above-disclosed optical schematic, the collimator is distanced at a focal length not from the downstream end of the MM delivery fiber, but from the Gaussian region of the top-hat beam. Accordingly, the beam waist now includes the light spot having a Gaussian distribution profile on the target surface exactly within the beam waist instead of the flattop intensity profile.

Both of the discussed aspects are applicable to step-index MM fibers. However the inventive schematic of the second aspect is relevant to graded fibers. The latter do not use total internal reflection to guide the light. Instead, they use refraction. The fiber's refractive index decreases gradually away from its center, finally dropping to the same value as the cladding at the edge of the core with a graded index. It is possible to establish a relative position among the fiber end, collimator and focusing lens in which the beam waist, formed on the surface to be treated, is characterized by the nearly Gaussian intensity distribution profile associated with the increased energy.

### BRIEF DESCRIPTION OF THE DRAWING

The above and other features will become more apparent with reference to the accompanying figures, which are not drawn to scale. The figures provide an illustration and a further understanding of the vatious aspects and features, and constitute a part of this specification, but do not represent the limits of any particular schematic or aspect. In the drawings, each identical or nearly identical component that appears in various figures is denoted by a like numeral. For purposes of clarity, not every component may be labeled in every figure. In the figures:

FIG. 1 illustrates an optical schematic of the known typical laser head configured to guide a flattop MM beam to the target.

FIG. 2 illustrates the inventive laser head configured to process the workpiece to be laser treated with one of the MM beam's Gaussian regions in accordance with the inventive concept.

FIG. 3 illustrates the optical schematic of the inventive laser head of FIG. 2.

FIG. 4 illustrates the beam downstream from the focusing lens of the optical schematic of FIG. 3 and sectional intensity distribution profiles of the beam.

FIG. 5 illustrates beam formed by the optical schematic of FIG. 3 and depth penetration of respective planes of the beam.

FIG. 6 illustrates a modified beam-shaping optical schematic configured in accordance with the inventive concept.

### SPECIIFIC DESCRIPTION

The inventive concept provides for greater process windows in material laser-based processing operations which typically require the use of high power and high quality MM beams. The concept is realized by the inventive optical schematics that transform a non-Gaussian intensity profile to a Gaussian intensity profile in the vicinity of the shaped beam's waist.

FIG. 2 illustrates an exemplary laser head 50 configured in accordance with the inventive concept and provided with the inventive optical schematic. The laser head 50 is a critical part of industrial laser systems which is positioned upstream from the workpiece(s) to be laser processed. The inventive laser head includes, among other optical and sometimes electronic components, a beam-shaping optical schematic elements including collimating lens 1 typically focused at the downstream end of a laser-beam delivering fiber 22 and thus spaced therefrom at a focal length.

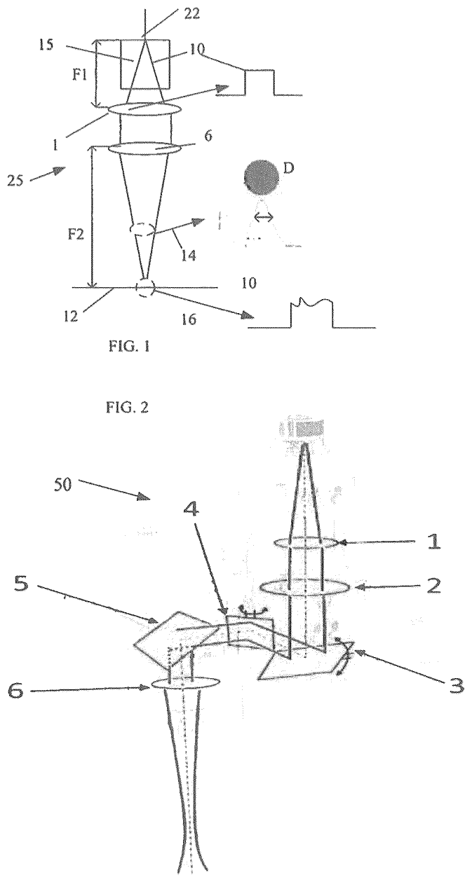

In simplest terms, collimation ensures that the light rays, which are incident on the input of collimator 1, travel parallel to each other downstream from its output. The laser head 50 may optionally have two rotating mirrors 3 and 5, and a stationary mirror 4. Eventually, the collimated beam impinges upon focusing lens 6 which focuses the beam on the surface of the workpiece to be laser processed. So far, the shown schematic is identical to that of FIG. 1 illustrating the workpiece which is laser treated by the flattop-shaped MM beam. The goal of the disclosed beam-shaping schematic is 1. to irradiate the workpieces with the beam having the Gaussian profile, and 2. to place the desired Gaussian region of the beam practically in the vicinity of the waist, immediately next to or in the waist region. In other words, the shown schematic includes a combination of optical elements arranged to transform a flattop or other shaped MM beam into the Gaussian beam with both the energy and DOF which are increased compared to the known prior art.

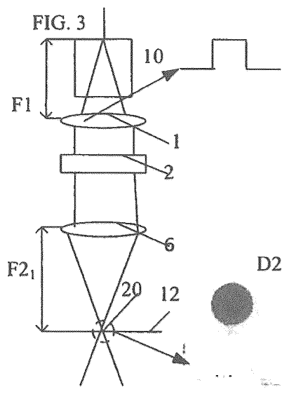

Referring now to FIGS. 2 and 3, the inventive concept is realized by introducing a diffractive optical element 2 which is mounted anywhere between collimator 1 and focusing lens 6 or downstream from focusing lens 6 at a very short distance depending on the focal length of this lens. For example, for a 200 mm focal length, this distance does not exceed 10 mm. The combination of diffractive element 2 and focusing lens 6 creates a region 20 in which light has a Gaussian intensity distribution. In other words, the lens-diffractive element doublet produces Bessel-Gaussian beam. In the shown schematic, diffractive element 2 provides for Gaussian beam region 20 to be practically adjacent to or within the beam waist at a distance F₂₁ from focusing lens 6 which is only slightly shorter than focal length F₂ of lens 6 in FIG. 1. In fact, so close Gaussian region 14 is to the waist that here the Gaussian region is considered to be within the waist including irradiated surface 12.

The diffractive element 2 may include, among others, a homogenizer, hologram and axicon. In the shown structure, element 2 is an axicon lens well known to one ordinary skill in the optics. Within the context of the disclosure, axicon 2 transforms the flattop intensity profile of beam 10 into a beam shape that can be mathematically described by a Bessel function and have a donut-shape intensity profile within the transformed beam's waist. The regions of the transformed MM Bessel beam 10 with Gaussian distribution are not symmetrical, and only the upper region 14 has the desired energy, as is will be discussed below. The operational principle of the axicon is common to any of appropriate diffractive optical components.

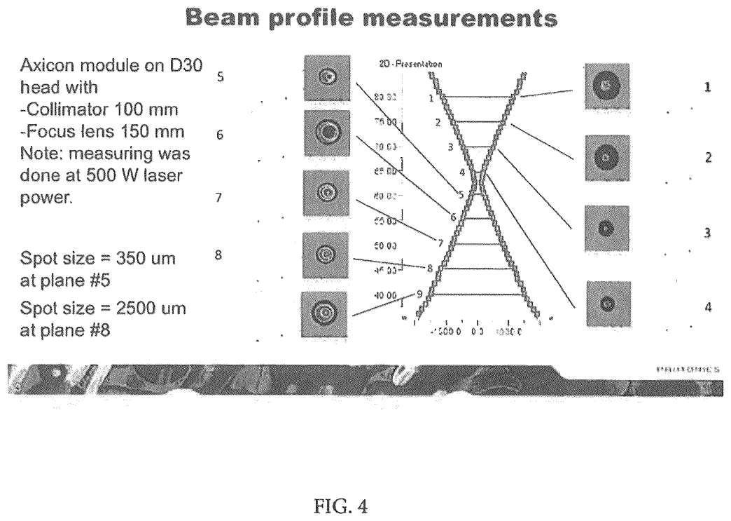

FIG. 4 shows plane views of the Bessel beam's regions with respective intensity profiles obtained by the schematic of FIGS. 2 and 3 along the light path between diffractive element 2 and a plane downstream from the beam waist which includes surface 12. As shown, the utmost top and bottom beam regions or planes 1 and 9 respectively are 40 mm apart and located symmetrically relative to the waist which extends between plane 4 and 5. The planes 1, 2 and 6-9 all show different profiles of the Bessel beam which differ from the Gaussian profile, In contrast, the profiles in respective planes 3 and particularly 4 are very close to the Gaussian distribution. The plane 4 is the most appealing section since it is located practically within the waist which indicates that the energy there is close to a maximum value. As to plane 5, despite the shown profile slightly differing from the Gaussian one, it is still appropriate for intended purposes.

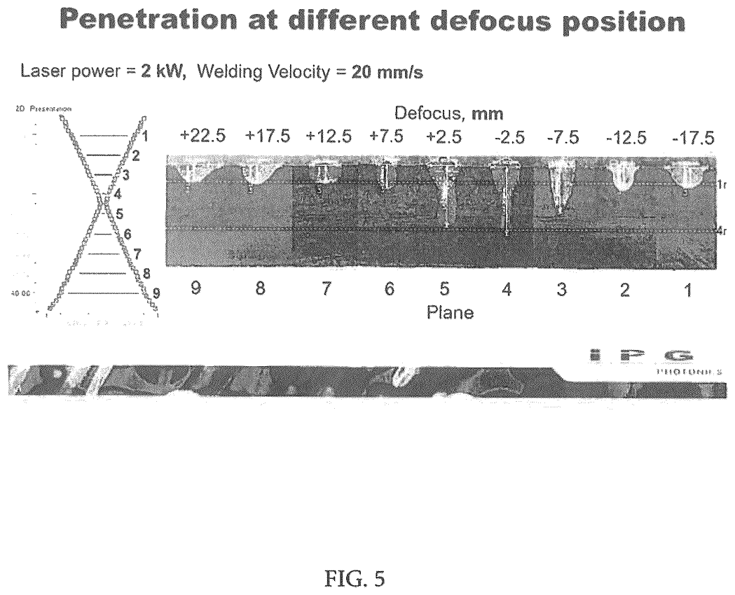

FIG. 5 shows that the DOF which is the difference between respective adjacent planes 4 and 5, defining the waist therebetween, is equal to 5 mm. Interestingly, the same schematic but without the axicon, such as the one shown I FIG. 1, provides the DOF of only 1 mm in the Gaussian region. Of course, the DOF depends on respective parameters of all optical components of laser head 50 including focusing lens 6 which in this experiment is 150 mm and collimator's focal length which is equal to 100 mm, as well as the laser output power. The smallest spot size, i.e., highest density is in plane 5 and equal to 350 μm. The plane 4 has a light spot size which is approximately equal to that of plane 5. In contrast, plane 8 is characterized by a 2500 mm spot size and is the largest one among the shown planes.

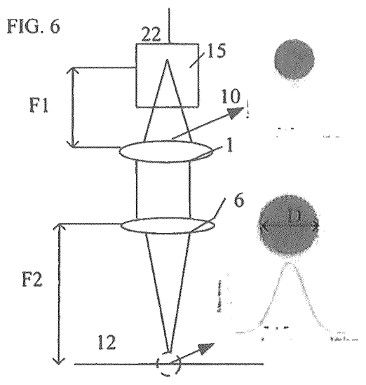

FIG. 6 illustrates another optical schematic of the beam shaper. While the latter shares the same optical elements, including, among others, end block 15, collimating and focusing lenses 1 and 6 respectively, with the prior art schematic of FIG. 1, it does not have diffractive element 2 critical to the schematic of FIGS. 2 and 3. Instead, it takes advantage of MM flattop beam 10 having regions with the Gaussian intensity distribution by displacing collimator I downstream from fiber end 22. The collimator is displaced such that it is the Gaussian region within end block 15 which is spaced from the collimator at the distance corresponding to the focal length of collimator 1 and not fiber end 22. As a result, the waist of beam 10 on surface 12, which is spaced from lens 6 at the original focal length F2, is characterized by the Gaussian intensity distribution region.

The delivery fiber 22 used in all previously disclosed schematics has a refractive step-index fiber. However, the schematics shown in FIG. 4 may be used in combination with a graded-index fiber which, by definition, is not a SM fiber. The operation of the schematic of FIG. 6 utilizing the graded index fiber is the same as with the step-index fiber.

The schematics disclosed herein in accordance with the present invention, are not limited in their application to the details of construction and the arrangement of components set forth in the following description or illustrated in the accompanying drawings. These aspects are capable of assuming other embodiments and of being practiced or of being carried out in various ways. Examples of specific implementations are provided herein for illustrative purposes only and are not intended to be limiting. In particular, acts, components, elements, and features discussed in connection with any one or more embodiments are not intended to be excluded from a similar role in any other embodiments.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Having thus described several schematics of the inventive concept, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

1. A beam-shaper for transforming a MN beam with a non-Gaussian intensity distribution profile, comprising:
an end block fused to a downstream end of a fiber which guides the MM beam along a path;
a collimator receiving and collimating the MM beam downstream from the end block; and
a focusing lens located in a fixed position and forming a beam waist in a focal plane of the focusing lens on a workpiece to be laser processed, wherein the beam waist has a Gaussian intensity profile.

2. The beam shaper of claim 1, wherein the collimator is spaced from in interface between the downstream end of the fiber and the end block at a distance equal to a focal length of the collimator, the MM beam having a flattop intensity distribution profile.

3. The beam shaper of claim 2 further comprising a diffractive optical element spaced downstream from the end block and configured to transform the MM flattop beam to a Bessel beam, wherein the beam waist of the Bessel beam is located in the focal plane of the focusing lens on the workpiece and has the Gaussian intensity distribution profile.

4. The beam shaper of claim 3, wherein the diffractive optical element is located between the collimator and focusing lens.

5. The beam shaper of claim 3, wherein the diffractive element is located downstream from the collimating lens.

6. The beam shaper of claim 3, wherein the diffractive optical element in an axicon, hologram or homogenizer.

7. The beam shaper of claim 3, wherein the end block, collimator, diffractive optical element and focusing lens are mounted to a housing of a laser head of a high power fiber laser welding system.

8. The beam shaper of claim 1, wherein the collimator is spaced downstream from the end block such that a focal plane of the collimator is located within the end block and coincides with a Gaussian beam region of the MM beam having a Gaussian density distribution, wherein the Gaussian region is focused in the focal plane of the focusing lens on the workpiece to be laser treated.

9. The beam shaper of claim 1, wherein the end block, which is fused to the downstream end of the fiber, collimator and focusing lens are mounted to a housing of a laser head of a high power fiber laser welding system.

10. The beam shaper of claim 9, wherein the fiber is a step-index fiber or graded index fiber.

11. The beam shaping system of claim 1 further comprising a plurality of movable mirrors located upstream from the focusing lens and mounted along with the collimator and focusing lens to a laser head.

12. The laser welding apparatus of claim 11 further comprising a robotic arm supporting the laser head, the fiber delivering the MM beam from a fiber laser or YAG laser source operating in a CW, QCW or pulsed regime.

13. A method of transforming a MM beam with a non-Gaussian intensity distribution profile, comprising:
guiding the MM beam in a MM delivery fiber;
coupling the MM beam into an end block of a laser head, the laser block being bonded to a downstream end of the delivery fiber;
collimating the MM beam within the laser head by a collimator; and
focusing the collimated MM beam on a surface of workpiece to be laser processed by a collimating lens within the laser head, thereby forming a waist of the MM beam on a workpiece to be laser treated, wherein a region of the MM beam, characterized by a Gaussian intensity distribution, is formed in a vicinity of the waist of the MM beam without displacing the focusing lens.

14. The method of claim 13, wherein forming the beam region with the Gaussian intensity in the waist of the MM beam includes:
focusing the collimator on the downstream end of tthe delivery fiber;
trans-fmning the MM collimated bearn into as Bessel beam; and
focusing the Bessel beam so that the Gaussian region of the MM beam is located within the waist.

15. The method of claim 13, wherein forming the beam region with the Gaussian intensity in the waist includes focusing the collimator on the Gaussian region of the MM beam within the end block.
